(19) United States
(12) Patent Application Publication
(10) Pub. No.: US 2004/0151795 A1
(43) Pub. Date: Aug. 5, 2004

(54) Cast secondary part for electric motors

(76) Inventors: Thomas Hoppe, Schwabhausen (DE); Hermann Sailer, Hohenkammer (DE)

Correspondence Address: HENRY M FEIEREISEN, LLC, 350 FIFTH AVENUE, SUITE 4714, NEW YORK, NY, 10118, US

(21) Appl. No.: 10/480,025

(22) PCT Filed: Jun. 6, 2002
(86) PCT No.: PCT/EP02/06245

(30) Foreign Application Priority Data
Jun. 13, 2001 (DE) 10129010.1

(51) Int. Cl. B29C 45/00

(52) U.S. Cl. 425/3; 425/542

(57) ABSTRACT

The invention relates to a secondary part for a motor, comprising at least one carrier element (10) and several permanent magnets (12) and a cast body made of plastic, whereby the permanent magnets (12) are cast therein. According to the invention, the cast body is made of thermoplastic material. According to the inventive method, the cast body is produced in a molding tool (110, 130) of an injection molding machine. Positioning elements (140) are provided in the molding tool (130) in order to fix the permanent magnets (12) on the carrier element (10). The positioning elements are withdrawn from the cavity of the molding tool after the first filling phase. The thus resulting voids are filled in a second filling phase.

The invention relates to a cast secondary part for electric motors, a method for its manufacture as well as an apparatus for carrying out the method.

Secondary parts for synchronous electric motors, which may be configured as rotary motors or linear motors, normally include a carrier element of magnetizable material and several permanent magnets which interact during operation with an electrically fed primary part. The permanent magnets are embedded in a cast body of, for example, polyurethane or epoxy resin, for protection against damages and corrosion (DE-A-199 36 064).

The carrier element with mounted permanent magnets are placed in this known method in a mold, and subsequently polyurethane or epoxy resin is poured, optionally at elevated pressure and elevated temperature, to ensure a complete infiltration of the casting compound into all voids. In order to further ensure the absence of any cracks in the material during the unavoidable shrinkage of the cast body during curing or reaction time, DE-A-199 36 064 proposes to cover the surfaces of the permanent magnets, which surfaces later face the primary part, with a non-woven material before casting.

Although satisfactory production results can be realized with the known method, the demands on the dimensional stability of the cast body have risen on the other hand. Furthermore, the unavoidable curing or reaction times of the casting compound lead to relatively long clock times and several molds must be used simultaneously in the production.

It is therefore the object of the invention to provide a secondary part for electric motors, which is producible in short clock times and exhibits dimensional stability of the cast body. Furthermore, a method as well as an apparatus for carrying out the method for making a secondary part according to the invention should be provided.

This object is attained by a secondary part according to claim 1, by a method with the features of claim 2 and by an apparatus according to claim 8; the dependent claims relate to advantageous configurations of the invention.

The invention is based on the surprising recognition that despite the high temperature during injection of thermoplastic material (200° and more), which range above the Curie points of some ferromagnetic materials, no significant impairment of the magnetization of the permanent magnets can be detected in the finished secondary part; this disproves a widely accepted supposition in the skilled art.

The manufacture of secondary parts with cast bodies of thermoplastic materials is able to exploit all advantages of the injection molding technique as proven in other fields. Thus, short clock times are possible as there is no waiting for reaction or curing times, wherein only a single tool (casting mold) is required. Shrinkage of the cast body can be counteracted by an afterpressure control, so that the finished secondary parts have a superior dimensional stability, i.e. the dimensions vary only slightly.

Disposal of the secondary parts at the end of the service life is simpler because thermoplastic materials or monomeric materials can easily be recycled, unlike PUR or epoxy resins. Furthermore, thermoplastic materials are more cost-efficient than PUR casting compounds.

Advantageously, the secondary parts according to the invention are made by an injection molding device known per se, which includes a molding tool and an injection unit. The permanent magnets are hereby preferably pre-mounted onto the carrier element, and subsequently the carrier element is placed with the permanent magnets in the mold cavity of the molding tool, and the cast body is cast. As an alternative, it is also possible to position only the permanent magnets in the mold cavity and to embed them in the cast body. The thus-formed cast body can then be applied on a suitable carrier element.

In general, it is possible to use magnetic materials for the molding tool, although non-magnetic materials (ceramic materials, special steel, etc.) are preferred as they are easier to handle in the production process.

In order to prevent a shift of the permanent magnets as a consequence of magnetic forces and flow forces during the injection operation, positioning elements are preferably provided in the molding tool which hold the magnets in place at the start of injection, and later can be withdrawn from the mold cavity, for example during the afterpressure phase, so that in this phase the resultant residual voids can be filled.

Handling of the secondary parts, the carrier elements with the permanent magnets, and/or the permanent magnets is preferably realized via switchable and/or pole-reversible electromagnets.

Surfaces that are free of voids and at the same time thin can be ensured by using a compression function of injection molding machines.

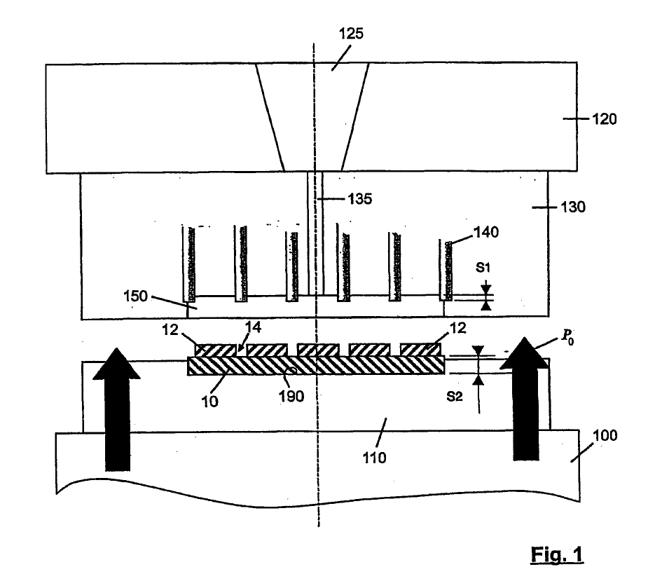

An exemplified embodiment of the invention will now be described with reference to FIGS. 1 to 4 which illustrate schematically side views of a molding tool at various steps for making a secondary part for a linear motor.

According to FIG. 1, a moving platen 100 supports a first half-mold 110, and a second half-mold 130 is mounted to a fixed platen 120. The fixed platen 120 is formed with a nozzle channel 125 which ends in a sprue channel 135 in the second half-mold 130. The sprue channel 135 in turn ends in a cavity 150 in the second half-mold 130. The second half-mold 130 further supports positioning pins 140 which can be moved into the cavity 150 and moved out therefrom.

The first half-mold 110 includes a recess 160 for receiving a carrier element 10. This carrier element 10 is a carrier plate known per se and made of magnetizable material for linear arrangement of block-shaped magnetic elements 12 with intermediate spaces 14 in a manner known per se. Preferably, the permanent magnets are pre-fixed by gluing or the like.

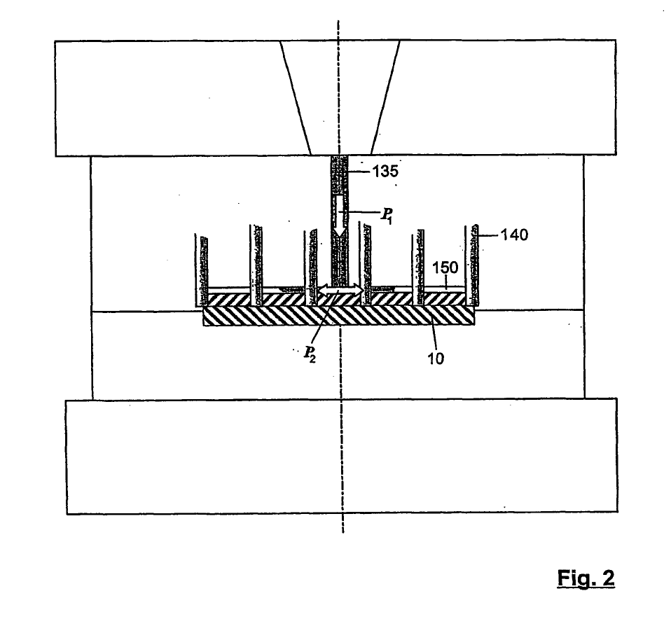

After depositing the carrier plate 10 with the attached permanent magnets 12 in the recess 160, for example by means of a handling device with electromagnets, the molding tool is closed, as indicated by the arrows P₀ in FIG. 1. The positioning elements 140, which preferably are round or square in cross section, are hereby shifted into positions depicted in FIG. 2, whereby the ends of the positioning pins are arranged in the intermediate spaces 14 between the permanent magnets and laterally of the first and last magnets of the row, respectively, and rest upon the carrier element 10.

The Figs. show each only one plane of positioning elements 140; in order to prevent a tilting of the permanent magnets 12 relative to one another, further positioning pins are provided along the longitudinal dimension of the permanent magnets 12 (normal to the drawing plane). Further positioning pins may be provided on the respective end sides of the permanent magnets 12 to prevent a displacement of the magnets in longitudinal direction.

In addition to the task to secure the permanent magnets, the positioning elements 140 further realize a compression of the carrier element 10 into the recess 180 of the half-mold 110.

As a consequence the carrier element 10 is held in place, and (when using magnetic materials for the half-mold 130) a “leaping” of the carrier element 10 with the permanent magnets 12 onto this half-mold can be prevented.

After fully closing the molding tool, thermoplastic material is injected via an injection nozzle (not shown) of an injection molding machine through the nozzle channel 125 and the injection channel 135 into the cavity 150, as indicated by arrow P₁, and distributed over the surfaces of the permanent magnets (P₂) as well as into the region of the intermediate spaces 14 between the positioning pins 140 and permanent magnets, respectively.

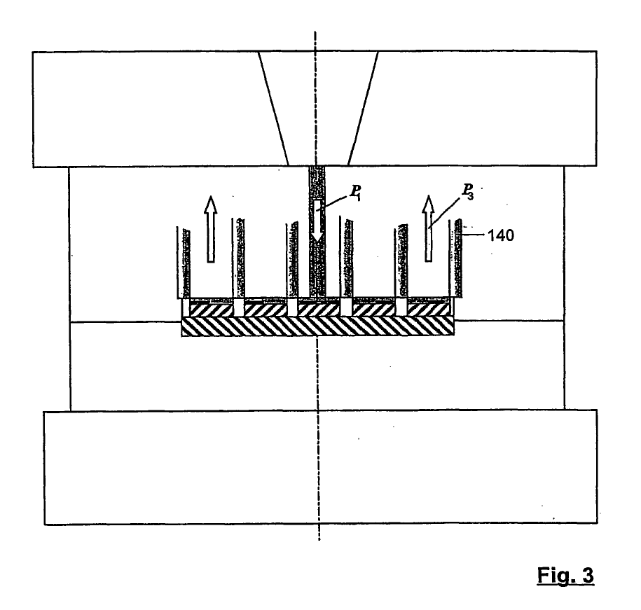

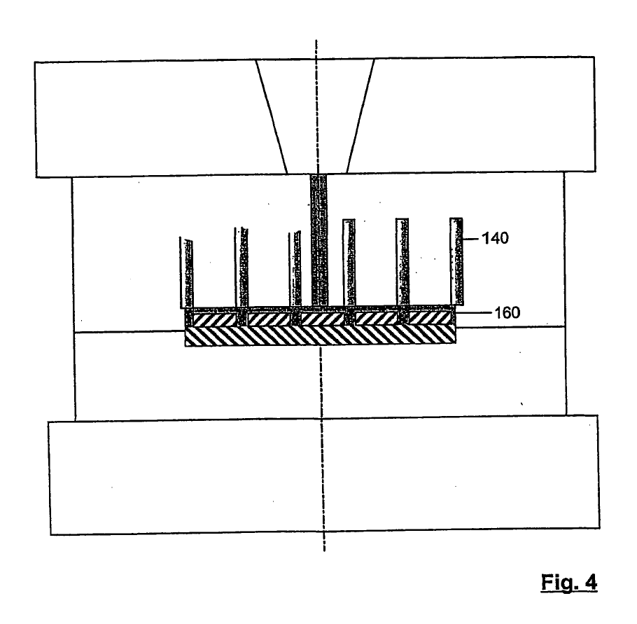

After the cavity 150 and thus also the intermediate spaces, which are bounded by the sides of the permanent magnets and the positioning pins 140, are filled with plastic material, the positioning pins 140 are withdrawn from the cavity (P₃ in FIG. 3), and the so-resultant residual voids are filled in an afterpressure phase (FIG. 4).

Subsequently, the mold is opened, the finished secondary part with formed cast body 160 is removed, preferably by means of a handling device with switchable electric motors, and the cycle can begin again.

The preceding description relates to the manufacture of a secondary part for a linear motor; in principal, the procedure according to the invention is equally applicable for the manufacture of secondary parts for rotary motors.

1. Secondary part for a motor with at least one carrier element (10), several permanent magnets (12) and a cast body (160) of plastic, in which at least the permanent magnets are cast, characterized in that the cast body is made of thermoplastic material.

2. Method of making a cast body (160) of a secondary part for a motor with the steps:
positioning permanent magnets (12) in the mold cavity (150) of an injection molding tool (110, 130), and filling the mold cavity by means of an injection molding unit.

3. Method according to claim 2, characterized in that the mold cavity (150) is filled with thermoplastic material.

4. Method according to claim 2 or 3, characterized in that the permanent magnets (12) are arranged on a carrier element (10) and then the cast body (160) is molded on the carrier element (10).

5. Method according to one of the claims 2 to 4, characterized in that movable positioning elements (140) are arranged in the mold cavity between the permanent magnets, wherein the positioning elements (140) are withdrawn from the mold cavity (150) after filling the mold cavity, and the thus-resulting voids are filled by a subsequent filling process.

6. Method according to claim 5, characterized in that the after-filling process includes the afterpressure phase of the injection molding process.

7. Method according to one of the preceding claims, characterized in that a compression step is carried out after conclusion of the filling operation or thereafter.

8. Apparatus for making secondary parts for motors, wherein the secondary parts have a cast body (16) with embedded permanent magnets (12), including at least two half-molds (110, 130) which form a closeable cavity, wherein at least one of the half-molds (130) supports positioning elements (140), wherein the positioning elements are movable between a first position, in which they project into the cavity and are intended for securement of the permanent magnets (12), and a second position.

9. Apparatus according to claim 8, characterized in that the half-molds include non-magnetic materials.

10. Apparatus according to claim 9, characterized in that the positioning elements (140) include non-magnetic materials.

11. Apparatus according to one of the claims 8 to 10, characterized in that it is connected to an injection molding unit.

12. Use of an injection molding machine with a mold unit and injection molding unit for making a secondary part according to claim 1.
